(19) United States
(12) Patent Application Publication
(10) Pub. No.: US 2012/0242711 A1
(43) Pub. Date: Sep. 27, 2012

(54) DISPLAY DEVICE AND METHOD OF DRIVING A DISPLAY PANEL

(76) Inventors: Sang-Hyun CHOI, Yongin-si (KR); Young-Nam Yun, Yongin-si (KR); Jung-Mi Jang, Yongin-si (KR); Sung-Kwon Kim, Yongin-si (KR)

(21) Appl. No.: 13/345,888

(22) Filed: Jan. 9, 2012

(30) Foreign Application Priority Data
Mar. 23, 2011 (KR) 10-2011-0025681

(51) Int. Cl. G09G 5/10; G06F 3/038

(52) U.S. Cl. 345/690

(57) ABSTRACT

A display panel includes a display panel and a driving unit. The display panel has a plurality of pixels coupled to a plurality of gate lines, a plurality of data lines, and a plurality of storage lines. The driving unit sequentially applies a gate signal to the gate lines, to apply data voltages that are based on data signals to the data lines, and to selectively apply boost signals to the storage lines coupled to storage capacitors of the pixels based on color information related to each of the pixels, during each frame.

### CROSS REFERENCE TO RELATED APPLICATION

This application claims priority under 35 U.S.C. §119 to Korean patent Application No. 2011-0025681 filed on Mar. 23, 2011, the disclosure of which is hereby incorporated by reference herein in its entirety.

### BACKGROUND

1. Technical Field

Example embodiments relate to a display device. More particularly, example embodiments relate to a display device and a method of driving a display panel.

2. Description of the Related Art

Generally, a liquid crystal display (LCD) device may include a display panel having a plurality of pixels that includes a liquid crystal layer having a dielectric anisotropy material between a pixel electrode and a common electrode, and a driving unit that drives the display panel. The LCD device may display an image by controlling light transmittance of the liquid crystal layer based on an intensity of an electric field formed between the pixel electrode and the common electrode. A light output from a backlight unit passes through the liquid crystal layer and a color filter. Since the color filter allows a light having a particular color to pass through, each pixel of the display panel may display a light having a particular color.

### SUMMARY

Example embodiments are directed to a display device and a method of driving a display panel.

According to some example embodiments, a display panel comprises a driving unit, and a display panel having a plurality of pixels coupled to a plurality of gate lines, a plurality of data lines, and a plurality of storage lines

According to some example embodiments, the driving unit sequentially applies a gate signal to the gate lines, to apply data voltages that are generated based on data signals to the data lines, and to selectively apply boost signals to the storage lines coupled to storage capacitors of the pixels based on color information related to each of the pixels, during each frame.

In some embodiments, the driving unit may comprise a stabilization driver that receives a plurality of boost voltages to generate the boost signals, each of the boost voltages being related to each color, and configured to apply the boost signals to the storage capacitors of the pixels in response to the gate signals, to stabilize pixel voltages of the pixels according to the color information.

In some embodiments, the stabilization driver may comprise a plurality of stabilization driving circuits.

In some embodiments, each of the stabilization driving circuits may generate sub-boost signals based on one of the boost voltages, and sequentially applies the sub-boost signals to the pixels based on the color information in response to the gate signals.

In some embodiments, each of the stabilization driving circuits may comprise a plurality of stabilization driving blocks.

In some embodiments, each of the stabilization driving blocks may comprise a voltage control unit that outputs a boost voltage selecting signal in response to the gate signal, and a voltage output unit that selectively outputs one of a first boost voltage and a second boost voltage as one of the sub-boost signals through one of the storage lines based on the boost voltage selecting signal.

In some embodiments, each of the boost voltages may have a voltage level predetermined based on at least one of color coordinates of a backlight unit of the display device, characteristics of color filters of the display panel, and cell-gaps of the display panel.

In some embodiments, polarities of the boost signals may be inverted every frame.

In some embodiments, the boost signals may have a positive voltage level during a first frame, and have a negative voltage level during a second frame that follows the first frame.

In some embodiments, a first voltage level of a first boost signal that is applied by the driving unit to a plurality of first gate pixels arranged along a first gate line may be different from a second voltage level of a second boost signal that is applied by the driving unit to a plurality of second gate pixels arranged along a second gate line adjacent to the first gate line, during each frame.

In some embodiments, the pixels may include first pixels related to a first color information, second pixels related to a second color information, and third pixels related to a third color information.

In some embodiments, the driving unit may apply first sub-boost signals to the first pixels to stabilize first pixel voltages of the first pixels, apply second sub-boost signals to the second pixels to stabilize second pixel voltages of the second pixels, and apply third sub-boost signals to the third pixels to stabilize third pixel voltages of the third pixels.

In some embodiments, the first sub-boost signals may have a first voltage range based on the first color information, the second sub-boost signals may have a second voltage range based on the second color information, and the third sub-boost signals may have a third voltage range based on the third color information.

In some embodiments, the boost signal may include a plurality of sub-boost signals, and each of the sub-boost signals is related to each color.

In some embodiments, the stabilization driver may apply the sub-boost signals to the pixels based on the color information.

In some embodiments, each of the storage lines may include a plurality of sub-storage lines, and each of the sub-storage lines may be related to each color.

In some embodiments, the stabilization driver may apply the sub-boost signals through the sub-storage lines based on the color information.

In some embodiments, the sub-storage lines may be formed in parallel with a gate line, and each of the sub-storage lines may be coupled to the pixels related to the color information among pixels coupled to the gate line.

According to some example embodiments, a method of driving a display panel comprises sequentially applying a gate signal to a plurality of gate lines of the display panel during each frame, applying data voltages to a plurality of data lines of the display panel, and selectively applying boost signals to a plurality of storage lines coupled to storage capacitors of a plurality of pixels of the display panel based on color information related to each of the pixels.

In some embodiments, applying the boost signals may comprise receiving a plurality of boost voltages to generate the boost signals, and applying the boost signals to the storage capacitors of the pixels in response to the gate signals to stabilize pixel voltages of the pixels based on the color information.

In some embodiments, levels of the boost voltages may vary according to the color information related to the pixels.

In some embodiments, applying the boost signals may comprise generating sub-boost signals based on one of the boost voltages, and sequentially applying the sub-boost signals to the pixels based on the color information in response to the gate signal.

In some embodiments, applying the boost signals may comprise generating a boost voltage selecting signal in response to the gate signal, and selectively outputting one of a first boost voltage and a second boost voltage as the sub-boost signal through one of the storage lines based on the boost voltage selecting signal.

In some embodiments, polarities of the boost signals may be inverted every each frame.

In some embodiments, the boost signals may have a positive voltage level during a first frame, and have a negative voltage level during a second frame that follows the first frame.

In some embodiments, a first voltage level of a first boost signal that is applied to a plurality of first gate pixels arranged along a first gate line may be different from a second voltage level of a second boost signal that is applied to a plurality of second gate pixels arranged along a second gate line adjacent to the first gate line, during each frame.

In some embodiments, the boost signal may include a plurality of sub-boost signals, and each of the sub-boost signals may be related to each color.

In some embodiments, the sub-boost signals may be applied to the pixels based on the color information.

In some embodiments, each of the storage lines may include a plurality of sub-storage lines, and each of the sub-storage lines may be related to each color.

In some embodiments, the sub-boost signals may be applied through the sub-storage lines based on the color information.

### BRIEF DESCRIPTION OF THE DRAWINGS

The above and other features will become more apparent to those of ordinary skill in the art by describing in detail exemplary embodiments thereof with reference to the attached drawings in which:

FIG. 1 is a block diagram illustrating a display device in accordance with example embodiments;

FIG. 2 is a diagram illustrating a lower substrate of a display panel in a display device of FIG. 1;

FIG. 3 is a diagram illustrating a structure of each pixel arranged in a display panel in a display device of FIG. 1;

FIGS. 4A and 4B are circuit diagrams illustrating examples of a display panel in a display device of FIG. 1;

FIG. 5 is a block diagram illustrating an example of a stabilization driver in a display device of FIG. 1;

FIGS. 6A and 6B are block diagrams illustrating examples of a stabilization driving circuit in a stabilization driver of FIG. 5;

FIG. 7 is a circuit diagram illustrating an example of a stabilization driving block in a stabilization driving circuit of FIG. 6A;

FIG. 8 is a circuit diagram illustrating an example of a stabilization driving block in a stabilization driving circuit of FIG. 6B;

FIG. 9 is a timing diagram illustrating an operation of a display device of FIG. 1;

FIG. 10 is a flow chart illustrating a method of driving a display panel in accordance with example embodiments; and

FIG. 11 is a block diagram illustrating an electric device having a display device of FIG. 1.

### DETAILED DESCRIPTION

Example embodiments will now be described more fully hereinafter with reference to the accompanying drawings; however, they may be embodied in different forms and should not be construed as limited to the embodiments set forth herein.

It will be understood that when an element or layer is referred to as being “on,” “connected to” or “coupled to” another element or layer, it can be directly on, connected or coupled to the other element or layer or intervening elements or layers may be present. In contrast, when an element is referred to as being “directly on,” “directly connected to” or “directly coupled to” another element or layer, there are no intervening elements or layers present. Like or similar reference numerals refer to like or similar elements throughout. As used herein, the term “and/or” includes any and all combinations of one or more of the associated listed items.

Spatially relative terms, such as “beneath,” “below,” “lower,” “above,” “upper” and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if the device in the figures is turned over, elements described as “below” or “beneath” other elements or features would then be oriented “above” the other elements or features. Thus, the exemplary term “below” can encompass both an orientation of above and below. The device may be otherwise oriented (rotated 90 degrees or at other orientations) and the spatially relative descriptors used herein interpreted accordingly.

The terminology used herein is for the purpose of describing particular example embodiments only and is not intended to be limiting. As used herein, the singular forms “a,” “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

Example embodiments are described herein with reference to cross sectional illustrations that are schematic illustrations of illustratively idealized example embodiments (and intermediate structures). As such, variations from the shapes of the illustrations as a result, for example, of manufacturing techniques and/or tolerances, are to be expected. Thus, example embodiments should not be construed as limited to the particular shapes of regions illustrated herein but are to include deviations in shapes that result, for example, from manufacturing. The regions illustrated in the figures are schematic in nature and their shapes are not intended to illustrate the actual shape of a region of a device and are not intended to limit the scope of the embodiments.

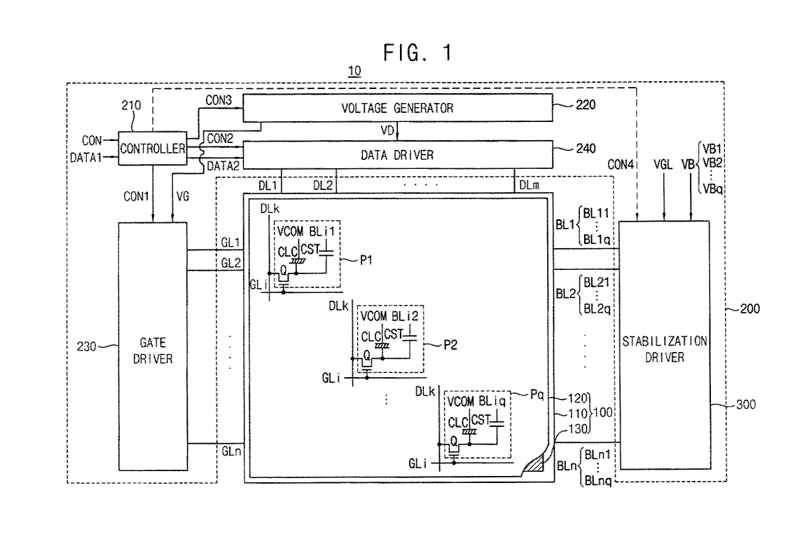

FIG. 1 is a block diagram illustrating a display device in accordance with example embodiments.

Referring to FIG. 1, the display device 10 may include a display panel 100 and a driving unit 200. The driving unit 200 may drive the display panel 100.

The display panel 100 may include a plurality of gate lines GL1 through GLn that are arranged in a first direction, a plurality of data lines DL1 through DLm that are arranged in a second direction, and a plurality of storage lines BL1 through BLn that are arranged in a third direction. Here, the first direction may be different from the second direction. For example, the first direction may be perpendicular to the second direction. The first direction may be substantially the same as the third direction. For example, the first direction may be parallel to the third direction. The display panel 100 may include a plurality of pixels P1 through Pq. According to some example embodiments, the pixels P1 through Pq may be arranged in a matrix manner, and may be coupled to the gate lines GL1 through GLn, the data lines DL1 through DLm, and the storage lines BL1 through BLn. Each of the pixels P1 through Pq may include a switching element Q, a liquid crystal capacitor CLC, and a storage capacitor CST. The switching element Q may be coupled to a corresponding gate line GLi, where i is an integer equal to or greater than 1 and equal to or less than n, a data line DLk, where k is an integer equal to or greater than 1 and equal to or less than m, and one of sub-storage lines BLi1 through BLiq. A first storage line BL1 through an (n)th storage line BLn are illustrated in FIG. 1. Here, an (i)th storage line BLi may include the sub-storage lines BLi1 through BLiq, where, i represent an (i)th row. Each of the sub-storage lines BLi1 through BLiq may be related to each color. That is, the sub-storage lines BLi1 through BLiq may be a first color storage line through a (q)th color storage line, respectively. As illustrated in FIG. 1, there are a plurality of (j)th color storage lines related to a (j)th color, where j is an integer equal to or greater than 1 and equal to or less than q. That is, the (j)th color storage lines may include sub-storage lines BL1j through BLnj.

Each of the pixels P1 through Pq may be placed below a corresponding color filter. Namely, each of the pixels P1 through Pq may include color information related to a color (e.g., red color, green color, and blue color, or yellow color, cyan color, and magenta color) of the corresponding color filter.

The display panel 100 may include a lower substrate 110, an upper substrate 120, and a liquid crystal layer 130 as well as the gate lines GL1 through GLn, the data lines DL1 through DLm, and the storage lines BL1 through BLn. The lower substrate 110 may include a plurality of switching elements Q and a plurality of pixel electrodes. The upper substrate 120 may include a plurality of common electrodes. The liquid crystal layer 130 may be placed between the lower substrate 110 and the upper substrate 120. In the display panel 100, each of the pixels P1 through Pq displays one of red color, green color, and blue color, or one of yellow color, cyan color, and magenta color (i.e., space division), or alternately displays red color, green color, and blue color, or yellow color, cyan color, and magenta color (i.e., time division). For this operation, the display panel 100 may include at least one red filter, at least one green filter, and at least one blue filter, or at least one yellow filter, at least one cyan filter, and at least one magenta filter above the pixel P1 through Pq. Consequently, the display panel 100 may display an image with a temporal mixture or a spatial mixture of red color, green color, and blue color, or yellow color, cyan color, and magenta color.

The driving unit 200 may include a controller 210, a voltage generator 220, a gate driver 230, a data driver 240, and a stabilization driver 300.

The driving unit 200 may sequentially apply a gate signal to the gate lines GL1 through GLn during each frame. The gate signal, for example, may have a voltage level for sequentially activating the gate lines GL1 through GLn during each frame. The driving unit 200 may sequentially apply data voltages that are generated based on data signals DATA2 to the data lines DL1 through DLm during each frame. During each frame, the driving unit 200 may selectively apply boost signals to the sub-storage lines BLi1 through BLiq coupled to storage capacitors CST of the pixels P1 through Pq based on color information related to each of the pixels P1 through Pq. Here, the color information may correspond to information indicating colors of the color filters formed above the pixels P1 through Pq. For example, the color information may correspond to information indicating colors that the pixels P1 through Pq display such as red color, green color, and blue color, or yellow color, cyan color, and magenta color.

The boost signal may include a first boost signal through an (n)th boost signal, each being applied to the first storage line BL1 through the (n)th storage line BLn, respectively. The (i)th boost signal may include a first sub-boost signal through a (q)th sub-boost signal, each being applied to the first sub-storage line BL±1 through the (q)th sub-storage line BLiq, respectively. Further, a (j)th sub-boost signal, where j is an integer equal to or greater than 1 and equal to or less than q, may be applied to (j)th pixels related to the (j)th color.

The driving unit 200 may apply the (j)th sub-boost signal to the (j)th pixels related to the (j)th color through one sub-storage line BLij among the sub-storage lines BL1j through BLnj (i.e., referred to as the (j)th color storage line). Here, a polarity of the (j)th sub-boost signal may be inverted every frame. The (j)th sub-boost signal may be generated based on a (j)th sub-boost voltage VBj that may alternately have a positive voltage level and a negative voltage level every frame. For example, first pixels P1 related to a first color may receive a first sub-boost signal through one sub-storage line BLi1 among the sub-storage lines BL11 through BLn1. Here, a polarity of the first sub-boost signal may be inverted every frame. The first sub-boost signal may be generated based on a first sub-boost voltage VB1 that may alternately have a positive voltage level and a negative voltage level every frame. The controller 210 may receive an input control signal CON and an input video signal DATA1 from an image source (e.g., an external graphic device). The input control signal CON may include a main clock signal, a vertical synchronization signal, a horizontal synchronization signal, and a data enable signal. The controller 210 may generate a data signal DATA2 based on the input video signal DATA1 to provide the data signal DATA2 to the data driver 240. Here, the data signal DATA2 may be a digital signal for operations of the display panel 100. In addition, the controller 210 may generate a first control signal CON1, a second control signal CON2, and a third control signal CON3 to provide the first control signal CON1, the second control signal CON2, and the third control signal CON3 to the gate driver 230, the data driver 240, and the voltage generator 220, respectively. The first control signal CON1 may be generated based on the input control signal CON to control driving timings of the gate driver 230. The second control signal CON2 may be generated based on the input control signal CON to control driving timings of the data driver 240. The third control signal CON3 may be generated based on the input control signal CON to control the voltage generator 220. According to some example embodiments, the controller 210 may generate a fourth control signal CON4 to provide the fourth control signal CON4 to the stabilization driver 300. The fourth control signal CON4 may be generated based on the input control signal CON to control driving timings of the stabilization driver 300.

The voltage generator 220 may receive an external power, may generate a gate driving voltage VG based on the external power to provide the gate driving voltage VG to the gate driver 230, and may generate a data driving voltage VD based on the external power to provide the data driving voltage VD to the data driver 240. The gate driver 230 may operate based on the gate driving voltage VG, and the data driver 240 may operate based on the data driving voltage VD. In example embodiments, the voltage generator 220 may generate a plurality of boost voltages VB1 through VBq to provide the boost voltages VB1 through VBq to the stabilization driver 300. The boost voltages VB1 through VBq are converted into boost signals by the stabilization driver 300, and then the boost signals are provided to corresponding pixels P1 through Pq. Further, the voltage generator 220 may generate a common voltage VCOM to provide the common voltage VCOM to a common electrode CE that is formed on the upper substrate 120 of the display panel 100.

During each frame, the gate driver 230 may sequentially apply a gate signal to the gate lines GL1 through GLn based on the first control signal CON1 output from the controller 210 and the gate driving voltage VG output from the voltage generator 220.

The data driver 240 may convert the data signal DATA2 output from the controller 210 into data voltages based on the second control signal CON2 output from the controller 210 and the data driving voltage VD output from the voltage generator 220. Here, the data voltages may be analog signals. Then, the data driver 240 may apply data voltages to the data lines DL1 through DLm.

The stabilization driver 300 may be coupled to the display panel 100 through the storage lines BL1 through BLn and the gate lines GL1 through GLn. The stabilization driver 300 may receive the boost voltages VB1 through VBq to generate the boost signals. Although not illustrated in FIG. 1, the stabilization driver 300 may be placed on one side of the display panel 100 while the gate driver 230 is placed on the opposite side of the display panel 100. Accordingly, the stabilization driver 300 may be coupled to the gate driver 230 through the gate lines GL1 through GLn that are coupled to the pixels P1 through Pq. Thus, an additional signal line for applying a gate signal VGL to the stabilization driver 300 may not be needed. The stabilization driver 300 may receive the gate signal VGL through the gate lines GL1 through GLn, and may apply the boost signals to storage capacitors CST of the pixels P1 through Pq in response to the gate signal VGL. As a result, the stabilization driver 300 may stabilize pixel voltages of the pixels P1 through Pq based on the color information. The stabilization driver 300 may alternately apply a high level voltage and a low level voltage to alternating storage lines. Namely, the stabilization driver 300 may apply a high level voltage to a certain storage line among the storage lines BL1 through BLn, and may apply a low level voltage to storage lines adjacent to the certain storage line. For example, the stabilization driver 300 may apply a high level voltage to a first storage line, and may apply a low level voltage to a second storage line adjacent to the first storage line, or vice versa. Here, levels of the boost voltages VB1 through VBq may vary according to the color information related to the pixels P1 through Pq.

Here, each of the boost voltages VB1 through VBq may have a predetermined voltage level to reduce a degree of dispersion in white color coordinates of the display device 10. The voltage levels of the boost voltages VB1 through VBq may be determined based on at least one of color coordinates of a backlight unit of the display device 10, characteristics of color filters of the display panel 100, and cell-gaps of the display panel 100. Each of the boost voltages VB1 through VBq may have a positive voltage level, or a negative voltage level. In addition, levels of the boost voltages VB1 through VBq may differ from each other according to the color information related to the pixels P1 through Pq.

Hereinafter, operations of the display panel 100 may be described.

When the gate signal is applied to one of the gate lines GL1 through GLn, and the data voltages are applied to the data lines DL1 through DLm, the switching elements Q in the pixels P1 through Pq coupled to the one of the gate lines GL1 through GLn may turn on. Thus, the data voltages may be applied to pixel electrodes PE of the pixels P1 through Pq coupled to the one of the gate lines GL1 through GLn. Meanwhile, the common voltage VCOM may be applied to the common electrode CE. Thus, the liquid crystal capacitor CLC is charged so that an electric field may be formed between the common electrode CE and the pixel electrode PE. Since a molecule arrangement of the liquid crystal layer 130 is changed by the electric field that is formed between the common electrode CE and the pixel electrode PE, light transmittance of the liquid crystal layer 130 may be changed.

The liquid crystal layer 130 may deteriorate due to polarization if a voltage of the same polarity is continuously applied to the liquid crystal layer 130. In order to prevent deterioration of the liquid crystal layer 130, the driving unit 200 may drive the gate lines GL1 through GLn, the data lines DL1 through DLm, the storage lines BL1 through BLn, and the common electrode CE so that a polarity of the pixel voltage that is applied to the pixels P1 through Pq or a polarity of the electric field that is formed between the common electrode CE and the pixel electrode PE may be periodically inverted.

As described above, the driving unit 200 may periodically invert a polarity of the electric field formed between the common electrode CE and the pixel electrode PE to prevent deterioration of the liquid crystal layer 130. For example, the driving unit 200 may drive the display panel 100 by inversion methods such as a dot inversion method, a line inversion method, a column inversion method, a frame inversion method, a Z-inversion method, and an active level shift (ALS) inversion method, etc. The dot inversion method may invert a polarity of the electric field with respect to alternating dots. Namely, a certain pixel may receive a data signal having a polarity opposite to data signals received by its adjacent pixels in a vertical direction (i.e., a column direction) and a horizontal direction (i.e., a row direction). The line inversion method may invert a polarity of the electric field with respect to alternating gate lines. The column inversion method may invert a polarity of the electric field with respect to alternating data lines. The frame inversion method may invert a polarity of the electric field with respect to alternating frames. The Z-inversion method may arrange a plurality of pixels in zigzags of a column direction. Thus, the Z-inversion method may substantially perform the dot inversion when data signals are applied to the pixels in a similar way to the column inversion method. The ALS inversion method may control a polarity of the electric field by applying the common voltage VCOM to the liquid crystal capacitor CLC and applying the boost voltage VB to the storage capacitor CST. The display device 10 may operate based on such various inversion methods. Hereinafter, however, only the ALS inversion method will be described for convenience of explanation.

When the driving unit 200 drives the display panel 100 by the ALS inversion method, the stabilization driver 300 may provide the boost signals to the display panel 100 through the storage lines BL1 through BLn. Here, polarities of the boost signals may be inverted every frame such that the boost signals may have a positive voltage level during a first frame, and may have a negative voltage level during a second frame that follows the first frame. During each frame, a voltage level of a first boost signal that is applied to pixels arranged along a first gate line may be different from a voltage level of a second boost signal that is applied to pixels arranged along a second gate line adjacent to the first gate line.

As described above, the display device 10 may apply the boost signals to the storage capacitors CST of the pixels P1 through Pq. Here, voltage levels of the boost signals may differ from each other according to color information related to the pixels P1 through Pq. Consequently, during each frame, levels of pixel voltages of the pixels P1 through Pq may be controlled based on colors that the pixels P1 through Pq display. Thus, the display device 10 may effectively control dispersion in white color coordinates of the display device 10.

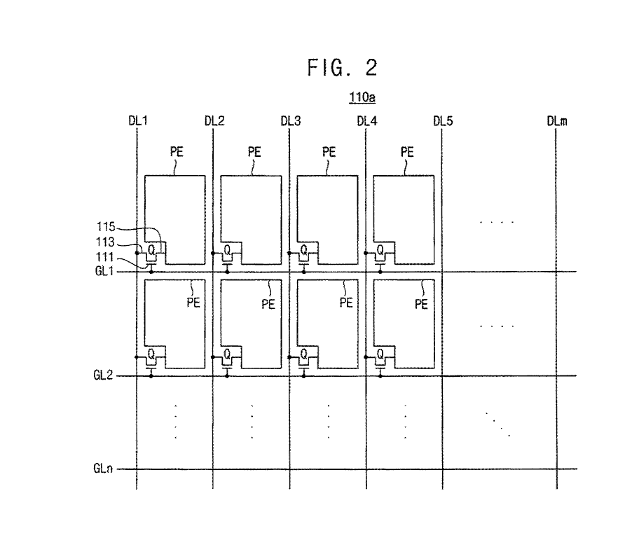

FIG. 2 is a diagram illustrating a lower substrate of a display panel in a display device of FIG. 1.

Referring to FIG. 2, the lower substrate 110 may include a plurality of pixels arranged at portions corresponding to intersections of the gate lines GL1 through GLn and the data lines DL1 through DLm. Each of the pixels may include the switching element Q and the pixel electrode PE. The switching element Q may be a thin film transistor (TFT) that includes a gate electrode 111, a source electrode 113, and a drain electrode 115. The gate electrode 111 may be coupled to one of the gate lines GL1 through GLn. The source electrode 113 may be coupled to one of the data lines DL1 through DLm. The drain electrode 115 may be coupled to the pixel electrode PE and a storage capacitor CST. In example embodiments, the pixels may include first pixels related to first color information, second pixels related to second color information, and third pixels related to third color information.

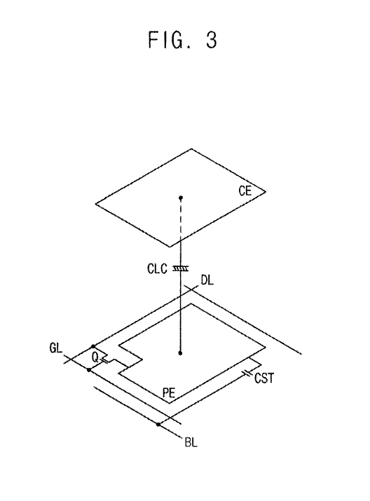

FIG. 3 is a diagram illustrating a structure of each pixel arranged in a display panel in a display device of FIG. 1.

Referring to FIG. 3, each of the pixels may include the switching element Q, the liquid crystal capacitor CLC, and the storage capacitor CST. According to some example embodiments, the switching element Q may correspond to a thin film transistor (TFT) using amorphous silicon.

The switching element Q may be placed on a lower display substrate. The switching element Q (e.g., a thin film transistor) may provide a data signal to the liquid crystal capacitor CLC in response to a gate signal. As illustrated in FIG. 3, the gate signal may be input from a gate line GL, and the data signal may be input from a data-line DL. The switching element Q may be coupled to the gate line GL via its gate terminal, may be coupled to the data line DL via its source terminal, and may be coupled to the liquid crystal capacitor CLC via its drain terminal. The liquid crystal capacitor CLC may be charged by a voltage difference between the data signal and the common voltage. The data signal may be applied to the pixel electrode PE of the liquid crystal capacitor CLC, and the common voltage may be applied to the common electrode CE of the liquid crystal capacitor CLC. As described above, the liquid crystal layer may be placed between the pixel electrode PE and the common electrode CE. Hence, the light transmittance of the liquid crystal layer may be controlled by an intensity of the electric field formed between the pixel electrode PE and the common electrode CE (i.e., referred to as a charged voltage). In case of a normally black mode, for example, the light transmittance of the liquid crystal layer may increase as the intensity of the electric field formed between the pixel electrode PE and the common electrode CE increases. On the other hand, the light transmittance of the liquid crystal layer may decrease as the intensity of the electric field formed between the pixel electrode PE and the common electrode CE decreases. According to some example embodiments, the liquid crystal capacitor CLC may include the pixel electrode PE formed on the lower display substrate, the common electrode CE formed on the upper display substrate, and the liquid crystal layer placed between the pixel electrode PE and the common electrode CE. However, the structure of the liquid crystal capacitor CLC is not limited thereto. For example, the common electrode CE of the liquid crystal capacitor CLC may be formed on the lower display substrate. In this case, the common electrode CE may receive the common voltage from a signal line (not illustrated) formed on the lower display substrate. In addition, the pixel electrode DE is coupled to the drain terminal of the switching element Q so that the pixel electrode DE may receive the data signal from the data line DL coupled to the source terminal of the switching element Q. In one example embodiment, a low common voltage may be applied to the pixels when a data signal of positive polarity is applied to the pixels. On the other hand, a high common voltage may be applied to the pixels when a data signal of negative polarity is applied to the pixels. As a result, the charged voltage (i.e., the intensity of the electric field formed between the pixel electrode PE and the common electrode CE) is greater than a voltage level of the data signal so that power consumption may be substantially reduced. The storage capacitor CST may maintain the charged voltage of the liquid crystal capacitor CLC. That is, the storage capacitor CST may assist the liquid crystal capacitor CLC. The storage capacitor CST may be formed by placing an insulator between the pixel electrode PE and the storage line BL. Although not illustrated in FIG. 3, the color filters may be arranged on the upper display substrate. Polarizing plates may be attached to the upper display substrate, and/or the lower display substrate. Each of the storage capacitors CST may be coupled to a storage line BL based on a color of each color filter. Thus, the storage capacitors CST may independently receive boost signals through the storage line BL. Namely, the storage capacitors CST of pixels related to a certain color may receive boost signals having a voltage level different from that of the storage capacitors CST of other pixels related to a different color.

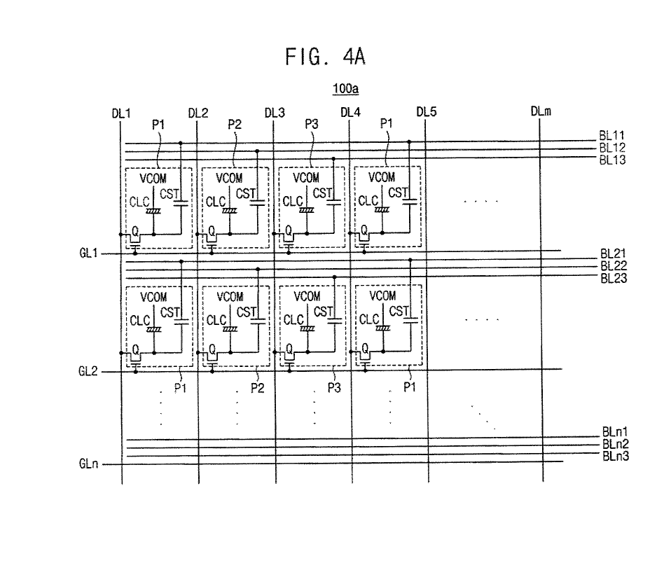

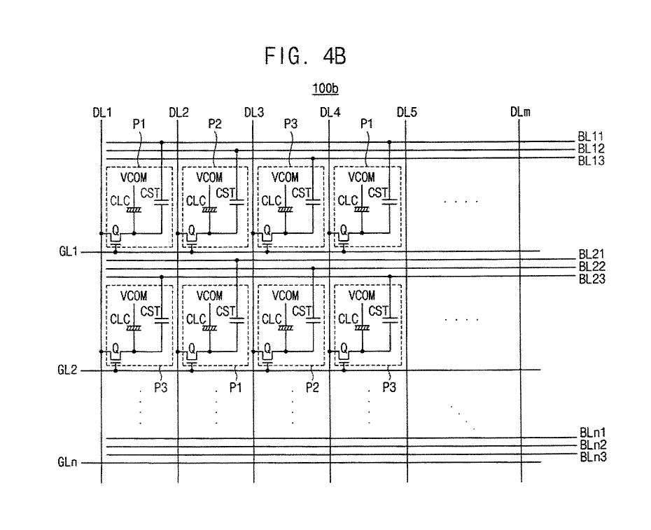

FIGS. 4A and 4B are circuit diagrams illustrating examples of a display panel in a display device of FIG. 1.

Referring to FIG. 4A, the display panel 100a includes a plurality of pixels P1 through P3. The pixels P1 through P3 may include first pixels P1 related to first color information, second pixels P2 related to second color information, and third pixels P3 related to third color information. Although, for convenience of explanation, three pixel groups related to three different colors are illustrated in FIG. 4A, embodiments are not limited thereto. That is, the display panel 100A may include more pixel groups related to more colors. In one example embodiment, the first color information may correspond to red color information, the second color information may correspond to green color information, and the third color information may correspond to blue color information. In another example embodiment, the first color information may correspond to yellow color information, the second color information may correspond to cyan color information, and the third color information may correspond to magenta color information.

Referring now to FIGS. 1 and 4A, the driving unit 200 may apply a first sub-boost signal to the first pixels P1 through sub-storage lines BL11 through BLn1 related to the first color so as to stabilize pixel voltages of the first pixels P1. The driving unit 200 may apply a second sub-boost signal to the second pixels P2 through sub-storage lines BL12 through BLn2 related to the second color so as to stabilize pixel voltages of the second pixels P2. The driving unit 200 may apply a third sub-boost signal to the third pixels P3 through sub-storage lines BL13 through BLn3 related to the third color so as to stabilize pixel voltages of the third pixels P3. In order to improve white color coordinates, voltage ranges of the first sub-boost signal, the second sub-boost signal, and the third sub-boost signal may vary according to the first color information, the second color information, and the third color information, respectively.

The boost signals may include a plurality of sub-boost signals. The sub-boost signals may be related to a plurality of colors, respectively. The stabilization driver 300 of FIG. 1 may apply the sub-boost signals to the pixels on the basis of the color information.

As described referring to FIG. 1, the storage lines BL1 through BLn may include a plurality of sub-storage lines. The sub-storage lines may be related to a plurality of colors. The stabilization driver 300 of FIG. 1 may apply the sub-boost signals to the pixels through the sub-storage lines BL1j through BLnj based on the color information.

The sub-storage lines BL1j through BLnj may be formed in parallel with corresponding gate lines GL1 through GLn. Each of the sub-storage lines BL1j through BLnj may be coupled to the pixels related to the color information among all pixels coupled to a corresponding gate line GL1 through GLn. For example, a sub-storage line BL13 related to a third color may be coupled to third pixels P3 among all pixels coupled to a first gate line GL1.

FIGS. 4A and 4B are circuit diagrams illustrating examples of a display panel in a display device of FIG. 1. Different arrangements of the pixels P1 through P3 are illustrated in FIGS. 4A and 4B. In detail, the pixels having the same color information are coupled to one data line DL1 in the display panel 100a of FIG. 4A, the pixels having different color information are coupled to one data line DL1 in the display panel 100b of FIG. 4B.

As described above, the display device 10 having the display panel 100a of FIG. 4A or the display panel 100b of FIG. 4B may apply boost signals having different voltage levels to the storage capacitors CST of the pixels P1 through Pq through the sub-storage lines BL1j through BLnj based on the color information of the pixels P1 through Pq. Consequently, during each frame, levels of pixel voltages of the pixels P1 through Pq may be controlled based on colors that the pixels P1 through Pq display. Thus, the display device 10 may effectively control dispersion in white color coordinates.

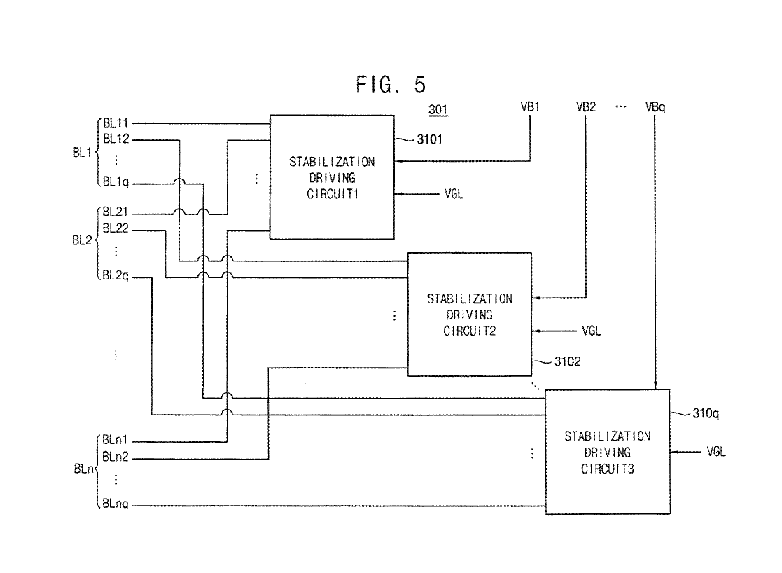

FIG. 5 is a block diagram illustrating an example of a stabilization driver in a display device of FIG. 1.

Referring to FIG. 5, the stabilization driver 301 may include a plurality of stabilization driving circuits 3101 through 310q. Based on boost voltages VB1 through VBq related to a plurality of colors, each of the stabilization driving circuits 3101 through 310q may generate a plurality of sub-boost signals related to the colors, respectively. In response to a gate signal VGL, each of the stabilization driving circuits 3101 through 310q may sequentially apply the sub-boost signals to the pixels related to a specific color through sub-storage lines BL1j through BLnj related to the specific color.

Referring now to FIG. 5, the stabilization driving circuits 3101 through 310q may include a first stabilization driving circuit through a (q)th stabilization driving circuit. Based on a first boost voltage VB1 related to first color information, the first stabilization driving circuit 3101 may generate a first sub-boost signal in response to the gate signal VGL that is sequentially activated along gate lines GL1 through GLn. The first stabilization driving circuit 3101 may provide the first sub-boost signal to the pixels P1 related to the first color information through the sub-storage lines BL11 through BLn1 related to the first color information. The stabilization driving circuits 3102 through 310q have similar structures and operations as the stabilization driving circuit 3101.

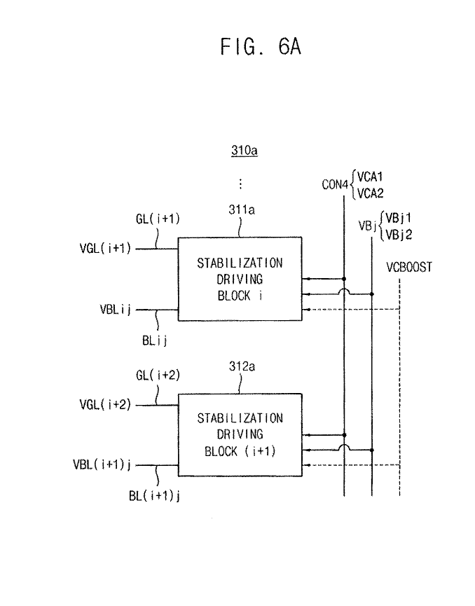

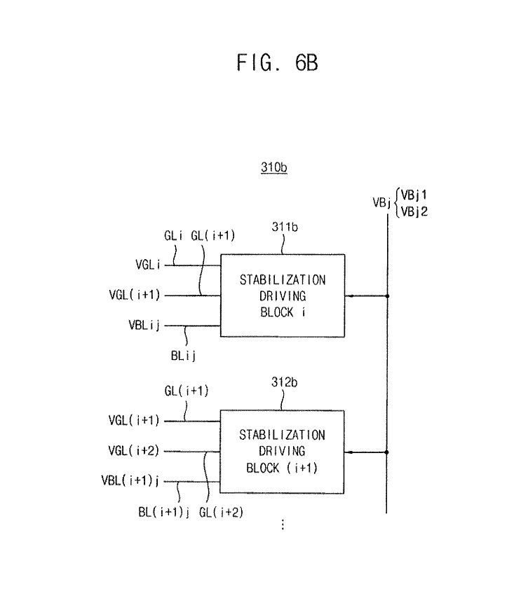

FIGS. 6A and 6B are block diagrams illustrating examples of a stabilization driving circuit in a stabilization driver of FIG. 5. In FIGS. 6A and 6B, i is an integer equal to or greater than 1 and equal to or less than n, and j is an integer equal to or greater than 1 and equal to or less than q.

Referring to FIG. 6A, a stabilization driving circuit 310a may include a plurality of stabilization driving blocks 311a and 312a. Although, for convenience of explanation, two stabilization driving blocks 311a and 312a are illustrated in FIG. 6A, embodiments are not limited thereto. That is, one stabilization driving circuit may include at least two stabilization driving blocks.

The number of the stabilization driving blocks 311a and 312a may be the same as the number of the gate lines GL1 through GLn coupled to the stabilization driver 301. For example, a first stabilization driving block through an (n)th stabilization driving block 311a and 312a that are sequentially arranged may be coupled to a first gate line through an (n)th gate line GL1 through GLn, respectively. Hence, each of the stabilization driving blocks 311a and 312a may operate in response to a sub-gate-line signal that is applied to one of the gate lines GL1 through GLn. An (i)th stabilization driving block 311a among the stabilization driving blocks 311a through 312a may receive a fourth control signal CON4 including a first selection control signal VCA1 and a second selection control signal VCA2. The (i)th stabilization driving block 311a may receive a negative boost voltage VBj1 and a positive boost voltage VBj2. The negative boost voltage VBj1 and the positive boost voltage VBj2 are related to a (j)th color. The negative boost voltage VBj1 may be applied as a negative boost signal to storage capacitors CST of (j)th pixels Pj coupled to an (i)th gate line GLi. The positive boost voltage VBj2 may be applied as a positive boost signal to the storage capacitors CST of the (j)th pixels Pj coupled to the (i)th gate line GLi.

The (i)th stabilization driving block 311a may be coupled to an (i+1)th gate line GL(i+1) and a sub-storage line BLij related to the (j)th color. The (i)th stabilization driving block 311a may receive a gate signal VGL(i+1) from the (i+1)th gate line GL(i+1). In response to the gate signal VGL(i+1), the (i)th stabilization driving block 311a may apply a sub-boost signal VBLij to (j)th pixels Pj coupled to the (i)th gate line GLi through the sub-storage line BLij related to the (j)th color.

In some example embodiments, each of the stabilization driving blocks 311a and 312a may further receive a boost holding voltage VCBOOST. For example, the (i)th stabilization driving block 311a may receive the gate signal VGL(i+1) from the (i+1)th gate line GL(i+1), and may apply the boost holding voltage VCBOOST to the (j)th pixels Pj coupled to the (i)th gate line GLi through the sub-storage line BLij related to the (j)th color in response to the gate signal VGL(i+1). When the gate signal VGL(i+1) applied to the stabilization driving block 311a is activated, the boost holding voltage VCBOOST may substantially have the same voltage level as the sub-boost signal VBLij. Consequently, the (j)th pixels Pj coupled to the (i)th gate line GLi may further receive the sub-boost signal VBLij from an extra current source to increase a capacity of current flowing through the (j)th pixels Pj.

Referring to FIG. 6B, a stabilization driving circuit 310b may include a plurality of stabilization driving block 311b and 312b. Although, for convenience of explanation, two stabilization driving blocks 311b and 312b are illustrated in FIG. 6B, embodiments are not limited thereto. That is, one stabilization driving circuit may include at least two stabilization driving blocks.

The (i)th stabilization driving block 311b may receive a negative boost voltage VBj1 and a positive boost voltage VBj2. The negative boost voltage VBj1 and the positive boost voltage VBj2 are related to a (j)th color. The negative boost voltage VBj1 may be applied as a negative boost signal to storage capacitors CST of (j)th pixels Pj coupled to an (i)th gate line GLi. The positive boost voltage VBj2 may be applied as a positive boost signal to the storage capacitors CST of the (j)th pixels Pj coupled to the (i)th gate line GLi.

The (i)th stabilization driving block 311b may be coupled to an (i)th gate line GLi, an (i+1)th gate line GL(i+1), and a sub-storage line BLij related to the (j)th color. The (i)th stabilization driving block 311b may receive a gate signal VGL(i+1) from the (i+1)th gate line GL(i+1), and a gate signal VGLi from the (i)th gate line GLi. In response to the gate signals VGL(i+1) and VGLi, the (i)th stabilization driving block 311b may apply a sub-boost signal VBLij to (j)th pixels Pj coupled to the (i)th gate line GLi through the sub-storage line BLij related to the (j)th color. For example, the (i)th stabilization driving block 311b may receive the gate signal VGLi from the (i)th gate line GLi, and may apply the negative boost voltage VBj1 or the positive boost voltage VBj2 to storage capacitors of the (j)th pixels Pj coupled to the (i)th gate line GLi in response to the gate signal VGLi.

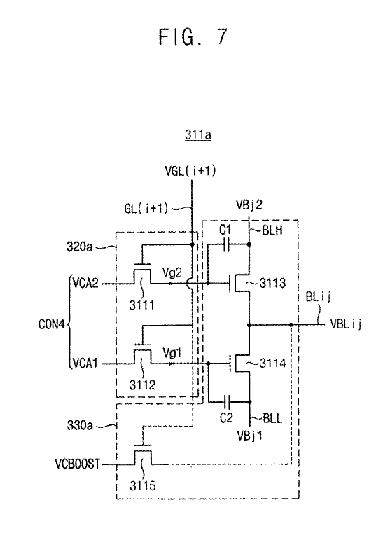

FIG. 7 is a circuit diagram illustrating an example of a stabilization driving block in a stabilization driving circuit of FIG. 6A.

Referring to FIG. 7, the (i)th stabilization driving block 311a may include a voltage control unit 320a and a voltage output unit 330a. Although the example of the (i)th stabilization driving block 311a is illustrated in FIG. 7, each of the stabilization driving blocks of FIG. 6A may have a similar structure as a circuit of FIG. 7.

The voltage control unit 320a may receive the fourth control signal CON4 including the first selection control signal VCA1 and the second selection control signal VCA2, and may output boost voltage selecting signals Vg1 and Vg2 in response to the gate signal VGL(i+1). The voltage output unit 330a may selectively output one of the first boost voltage VBj1 and the second boost voltage VBj2 as the sub-boost signal VBLij through the sub-storage line BLij based on the boost voltage selecting signals Vg1 and Vg2. During each frame, the voltage output unit 330a may hold the sub-boost signal VBLij to have a predetermined level based on the boost voltage selecting signals Vg1 and Vg2 output from the voltage control unit 320a. According to some example embodiments, the (i)th stabilization driving block 311a may be synchronized with the gate signal VGL(i+1), and may output the boost holding voltage VCBOOST through the sub-storage line BLij.

The voltage control unit 320a may include a first switching element 3111 and a second switching element 3112. The voltage output unit 330a may include a third switching element 3113, a fourth switching element 3114, a first capacitor C1, and a second capacitor C2. The first switching element 3111 has an input electrode coupled to the controller 210 and a control electrode coupled to the gate line GL(i+1). The second switching element 3112 has an input electrode coupled to the controller 210 and a control electrode coupled to the gate line GL(i+1). The third switching element 3113 has an input electrode coupled to a high level boost voltage line BLH, a control electrode coupled to an output electrode of the first switching element 3111, and an output electrode coupled to the sub-storage line BLij. The fourth switching element 3114 has an input electrode coupled to a low level boost voltage line BLL, a control electrode coupled to an output electrode of the second switching element 3112, and an output electrode coupled to the sub-storage line BLij. The first capacitor C1 may be formed between the control electrode of the third switching element 3113 and the input electrode of the third switching element 3113. The second capacitor C2 may be formed between the control electrode of the fourth switching element 3114 and the input electrode of the fourth switching element 3114. The voltage control unit 320a may control the first switching element 3111 and the second switching element 3112 based on the second selection control signal VCA2 and the first selection control signal VCA1. Consequently, the voltage control unit 320a may apply the boost voltage selecting signals Vg2 and Vg1 to the switching elements 3113 and 3114 of the voltage control unit 330a, respectively. The voltage output unit 330a may control the switching elements 3113 and 3114 based on the boost voltage selecting signals Vg2 and Vg1, respectively. Consequently, the voltage output unit 330a may output a positive boost voltage VBj2 or a negative boost voltage VBj1 that has a DC voltage level. Here, a level of the positive boost voltage VBj2 may be higher than a level of the negative boost voltage VBj1. Hence, the (i)th stabilization driving block 311a may receive the positive boost voltage VBj2 and the negative boost voltage VBj1, and may output a storage voltage VBLij through the sub-storage line BLij. Here, the polarity of the storage voltage VBLij may be inverted based on the boost voltage selecting signals Vg1 and Vg2 every frame. According to some example embodiments, the voltage output unit 330a may further include a fifth switching element 3115. In response to the gate signal VGL(i+1), the fifth switching element 3115 may output the boost holding voltage VCBOOST through the sub-storage line BLij during each frame. Here, the boost holding voltage VCBOOST has a level corresponding to a level of one of the boost voltages VBj2 and VBj1 that are output by the third switching elements 3113 and the fourth switching elements 3114, respectively. For example, the boost holding voltage VCBOOST may substantially have the same voltage level as one of the positive boost voltage VBj2 and the negative boost voltage VBj1.

Although not illustrated in FIG. 7, two wirings BLH and BLL may be vertically arranged in parallel. Here, the wirings BLH and BLL may carry the boost voltages VBj2 and VBj1, respectively. Since the stabilization driving blocks 311a are reversed (i.e., upside down) every row, connections between the third switching element 3113 and a second wiring BLH, and between the fourth switching element 3114 and a first wiring BLL may be switched every row. According to some example embodiments, the two wirings BLH and BLL may be crossed every row (i.e., switching their position every row). Thus, in an (i+1)th row, an input electrode of the third switching element 3113 may be coupled to the second wiring BLH, and an input electrode of the fourth switching element 3114 may be coupled to the first wiring BLL.

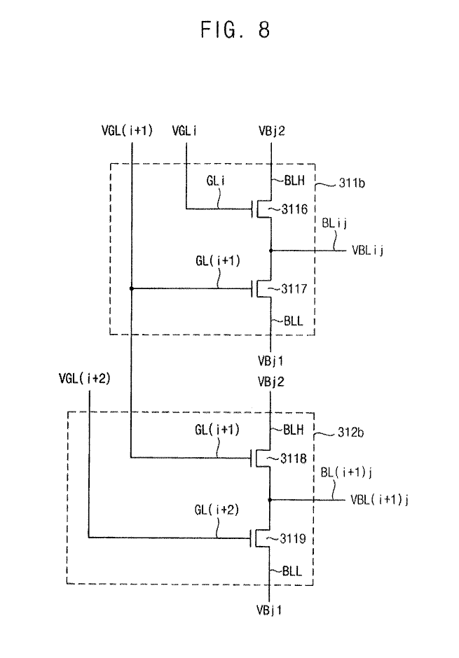

FIG. 8 is a circuit diagram illustrating an example of a stabilization driving block in a stabilization driving circuit of FIG. 6B.

Referring to FIG. 8, examples of an (i)th stabilization driving block 311b and an (i+1)th stabilization driving block 312b are illustrated in FIG. 8. Each of the stabilization driving blocks of FIG. 6B may have a similar structure as a circuit of FIG. 8.

The (i)th stabilization driving block 311b may include a first switching element 3116 and a second switching element 3117. A control electrode of the first switching element 3116 may be coupled to the (i)th gate line GLi to receive a gate signal VGLi from the (i)th gate line GLi. An input electrode of the first switching element 3116 may receive a positive boost voltage VBj2. A control electrode of the second switching element 3117 may be coupled to the (i+1)th gate line GL(i+1) to receive a gate signal VGL(i+1) from the (i+1)th gate line GL(i+1). An input electrode of the second switching element 3117 may receive a negative boost voltage VBj1.

On the other hand, the (i+1)th stabilization driving block 312b may receive the gate signal VGL(i+1), a gate signal VGL(i+2), and boost voltages VBj1 and VBj2 so that polarities of pixel voltages applied to pixels that are arranged in a row along the gate lines GL1 through GLn may be inverted with respect to alternating rows. Namely, a third switching element 3118 that is controlled by the (i+1)th gate signal VGL(i+1) may receive the positive boost voltage VBj2 via its input electrode, and a fourth switching element 3119 that is controlled by the (i+2)th gate signal VGL(i+2) may receive the negative boost voltage VBj1 via its input electrode. Except for such gate line connection, the (i+1)th stabilization driving block 312b has a similar structure as the (i)th stabilization driving block 311b.

Since the stabilization driving blocks 311b and 312b need two boost voltages (e.g., the positive voltage VBj2 and the negative voltage VBj1), two wirings BLH and BLL are formed (e.g., vertically) to receive the positive voltage VBj2 and the negative voltage VBj1, respectively. Hence, the wirings BLH and BLL may be crossed every row (i.e., switching their position every row). Connections between an input electrode of the first switching element 3116 and a second wiring BLH, and between the second switching element 3117 and a first wiring BLL may be switched every row. For example, with respect to (i)th pixels coupled to the (i)th gate line GLi, the input electrode of the second switching element 3117 may be coupled to the first wiring BLL, and the input electrode of the first switching element 3116 may be coupled to the second wiring BLH. On the other hand, with respect to (i+1)th pixels coupled to the (i+1)th gate line GL(i+1), the input electrode of the first switching element 3116 may be coupled to the first wiring BLL, and the input electrode of the second switching element 3117 may be coupled to the second wiring BLH.

According to some example embodiments, a magnitude of the negative boost voltage VBj1 applied through the first wiring BLL may be different from a magnitude of the positive boost voltage VBj2 applied through the second wiring BLH. While inverting polarities of pixel voltages of pixels that are connected to the stabilization driving block 311b every frame, magnitudes of the boost voltages VBj2 and VBj1 that are applied to the stabilization driving block 311b may be changed every frame. Polarities of the boost voltages VBj2 and VBj1 may be inverted during each blank that exists between two adjacent frames.

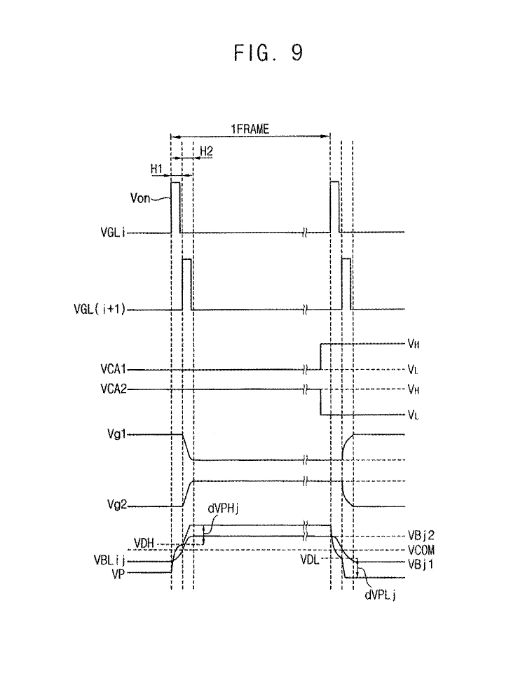

FIG. 9 is a timing diagram illustrating an operation of a display device of FIG. 1.

A first frame 1FRAME may include a plurality of horizontal periods H1 and H2. Here, the first frame 1FRAME may correspond to an odd frame. Since an image is displayed by a plurality of frames in a display panel 100, the first frame 1FRAME and a second frame that follows the first frame 1FRAME may be repeated.

Referring to FIGS. 7 and 9, an operation of the stabilization driving block 311a will be described. For example, in the first frame 1FRAME, a positive data voltage VDH may be applied to (j)th pixels that are coupled to the (i)th gate line GLi. Here, a first selection control signal VCA1 may correspond to a logic low level voltage VL, and a second selection control signal VCA2 may correspond to a logic high level voltage VH. The selection control signals VCA1 and VCA2 may have voltages of which polarities are inverted every frame in order to invert polarities of pixel voltages VP with respect to the gate lines GL1 through GLn. For example, as illustrated in FIG. 9, in a next frame (i.e., the second frame) that follows the first frame 1FRAME, the first selection control signal VCA1 may correspond to a logic high level voltage VH, and the second selection control signal VCA2 may correspond to a logic low level voltage VL. The selection control signals VCA1 and VCA2 may be inverted during each blank that exists between two adjacent frames.

In the first frame 1FRAME, a gate-on voltage Von is applied to the (i)th gate line GLi, and subsequently, the gate-on voltage Von is applied into the (i+1)th gate line GL(i+1). When the gate-on voltage Von is applied into the (i+1)th gate line GL(i+1), the first switching elements 3111 and the second switching elements 3112 are turned on. When the first switching element 3111 is turned on, it applies a second gate driving voltage Vg2 to a control electrode of the third switching element 3113 of the voltage output unit 330a. Here, gate driving voltages Vg1 and Vg2 may be substantially the same as the boost voltage selecting signals Vg1 and Vg2 of FIG. 7. As the first switching element 3111 is turned on, the second gate driving voltage Vg2 is substantially increased to the same logic level as the second selection control signal VCA2. A first capacitor C1 that is coupled between the control electrode of the third switching element 3113 and an input electrode of the third switching element 3113 is charged based on the second gate driving voltage Vg2 and a positive boost voltage VBj2. When the second switching element 3112 is turned on, it applies a first gate driving voltage Vg1 to a control electrode of the fourth switching element 3114 of the voltage output unit 330a. When the second switching element 3112 is turned on, the first gate driving voltage Vg1 is substantially decreased to the same logic level as the first selection control signal VCA1. A second capacitor C2 that is coupled between the control electrode of the fourth switching element 3114 and an input electrode of the fourth switching element 3114 is charged based on the first gate driving voltage Vg1 and a negative boost voltage VBj1. A maximum voltage level of the gate driving voltages Vg1 and Vg2 may be lower than a level of the gate-on voltage Von by a certain amount. A minimum voltage level of the gate driving voltages Vg1 and Vg2 may be higher than a level of a gate-off voltage Voff by a certain amount. When the first capacitor C1 and the second capacitor C2 are charged, the third switching elements 3113 and the fourth switching elements 3114 may maintain their states during the first frame 1FRAME.

The third switching elements 3113 and the fourth switching elements 3114 output a boost signal VBLij through a sub-storage line BLij based on the gate driving voltages Vg2 and Vg1. As illustrated in FIG. 9, during the first horizontal period H1 (i.e., before the gate signal VGL(i+1) that is applied to the (i+1)th gate line GL(i+1) has the gate-on voltage Von), the first gate driving voltage Vg1 having a logic high level turns on the fourth switching element 3114, and the fourth switching element 3114 applies the negative boost voltage VBj1 to the sub-storage line BLij. During the first horizontal period H1, a pixel voltage VP of (j)th pixels Pj coupled to the (i)th gate line GLi may increase from a negative level voltage to a positive data voltage VDH that is applied to switching elements Q of the (j)th pixels. During the second horizontal period H2 (i.e., when the gate signal VGL(i+1) that is applied to the (i+1)th gate line GL(i+1) has the gate-on voltage Von), the second gate driving voltage Vg2 having a logic high level turns on the third switching element 3113, and the third switching element 3113 applies the positive boost voltage VBj2 to the sub-storage line BLij. Consequently, the pixel voltage VP of the (j)th pixels Pj coupled to the (i)th gate line GLi may further increase by a rise voltage dVPHj in response to the boost signal VBLij corresponding to the boost voltage VBj2. The boost signal VBLij is applied to the storage capacitors CST through the sub-storage line BLij. Likewise, during the second frame that follows the first frame 1FRAME, the stabilization driver 300 applies the boost signal VBLij having the negative boost voltage VBj1 through the sub-storage line BLij so that the pixel voltage VP of the (j)th pixels Pj coupled to the (i)th gate line GLi may further decrease by a drop voltage dVPLj from a negative data voltage VDL.

As such, the display device 10 may apply boost signals to the storage capacitors CST of the pixels Pj, and voltage levels of the boost signals may differ from each other according to color information related to the pixels Pj. Consequently, during each frame, a level of a pixel voltage VP of each pixel Pj may be controlled based on a color that each pixel Pj displays. Thus, the display device 10 may effectively control dispersion in white color coordinates.

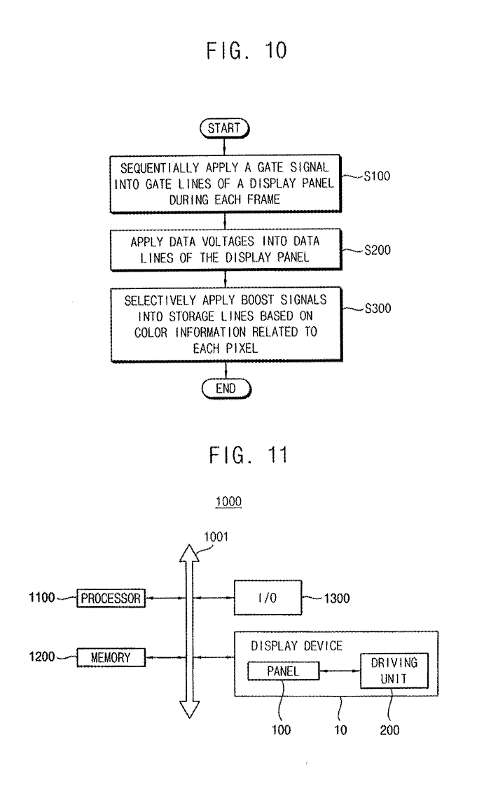

FIG. 10 is a flow chart illustrating a method of driving a display panel in accordance with example embodiments.

Referring to FIGS. 1 and 10, a gate signal may be sequentially applied to a plurality of gate lines GL1 through GLn of a display panel 100 based on a first control signal CON1 and a gate driving voltage VG during each frame (Step S100). Data signal DATA2 may be converted into data voltages based on a second control signal CON2 and a data driving voltage VD, and then the data voltages may be applied to a plurality of data lines DL1 through DLm (Step S200). Boost signals may be selectively applied to a plurality of sub-storage lines BLi1 through BLiq coupled to storage capacitors CST of a plurality of pixels P1 through Pq based on color information related to each of the pixels P1 through Pq (step S300). When the boost signals are applied, the driving unit 200 of FIG. 1 may receive a plurality of boost voltages VB1 through VBq to generate the boost signals, and may apply the boost signals to the storage capacitors CST of the pixels P1 through Pq in response to the gate signals so as to stabilize pixel voltages of the pixels P1 through Pq according to the color information. Here, levels of the boost voltages VB1 through VBq may vary according to the color information related to the pixels P1 through Pq.

FIG. 11 is a block diagram illustrating an electric device having a display device of FIG. 1.

Referring to FIG. 11, the electric device 1000 may include a processor 1100, a memory device 1200, an input/output (I/O) device 1300, and a display device 10.

The processor 1100 may perform specific calculations, or computing functions for various tasks. For example, the processor 1100 may correspond to a microprocessor, a central processing unit (CPU), etc. The processor 1100 may be coupled to the memory device 1200 via a bus 1001. The processor 1100 may be coupled to the memory device 1200 and the display device 10 via an address bus, a control bus, and/or a data bus. In addition, the processor 1010 may be coupled to an extended bus such as a peripheral component interconnection (PCI) bus.

For example, the memory device 1200 may include at least one volatile memory device such as a dynamic random access memory (DRAM) device, a static random access memory (SRAM) device, etc and/or at least one non-volatile memory device such as an erasable programmable read-only memory (EPROM) device, an electrically erasable programmable read-only memory (EEPROM) device, a flash memory device, etc. The memory device 1200 may store software performed by the processor 1100. The I/O device 1300 may be coupled to the bus 1001. The I/O device 1300 may include at least one input device (e.g., a keyboard, a keypad, a mouse, etc), and/or at least one output device (e.g., a printer, a speaker, etc). The processor 1100 may control operations of the I/O device 1300.

The display device 10 may be coupled to the processor 1100 via the bus 1001. As described above, the display device 10 may include a display panel 100 and a driving unit 200. The display panel 100 may include pixels that are coupled to gate lines GL1 through GLn and data lines DL1 through DLm. The driving unit 200 may drive the display panel 100. During each frame, the driving unit 200 may sequentially apply a gate signal into the gate lines GL1 through GLn, may apply data voltages into the data lines DL1 through DLm, and may apply a common voltage VCOM into the pixels. As described above, when the display device 10 applies boost signals to the pixels of the display panel 100, voltage levels of the boost signals may differ from each other according to color information related to the pixels. As a result, the display device 10 may effectively control dispersion in white color coordinates.

The electric device 1000 may correspond to a digital television, a cellular phone, a smart phone, a personal digital assistant (PDA), a portable multimedia player (PMP), a MP3 player, a laptop computer, a desktop computer, a digital camera, etc.

Example embodiments may control a voltage level of boost signals that are applied to storage capacitors of pixels in a display panel according to their color information so that white color coordinates of a display device having the display panel may be effectively improved. Thus, the example embodiments may be usefully employed in various fields which require color display panels. Particularly, embodiments may be applied to a computer monitor, a digital television, a laptop, a digital camera, a video camcorder, a cellular phone, a smart phone, an MP3 player, a navigation device, a video phone, etc.

By way of summation and review, a white pattern of a display panel, may have a relatively high degree of dispersion in white color coordinates due to dispersion in color coordinates of a backlight unit, dispersion in cell gaps, and dispersion in a color filter process. A degree of dispersion in white color coordinates can be reduced by employing a backlight unit having a single rank in the display panel.

Example embodiments are directed to a display device capable of applying a specific voltage to a storage capacitor of a pixel based on a color that the pixel displays in a display panel. Example embodiments are also directed to a method of driving a display panel, by which a specific voltage is applied to a storage capacitor of a pixel based on a color that the pixel displays in a display panel.

Exemplary embodiments have been disclosed herein, and although specific terms are employed, they are used and are to be interpreted in a generic and descriptive sense only and not for purpose of limitation.

What is claimed is:

1. A display device, comprising:
a display panel having a plurality of pixels coupled to a plurality of gate lines, a plurality of data lines, and a plurality of storage lines; and
a driving unit configured to sequentially apply a gate signal to the gate lines, to apply data voltages that are based on data signals to the data lines, and to selectively apply boost signals to the storage lines coupled to storage capacitors of the pixels based on color information related to each of the pixels, during each frame.

2. The display device as claimed in claim 1, wherein the driving unit includes a stabilization driver configured to receive a plurality of boost voltages to generate the boost signals, each of the boost voltages being related to each color and configured to apply the boost signals to the storage capacitors of the pixels in response to the gate signals, to stabilize pixel voltages of the pixels according to the color information.

3. The display device as claimed in claim 2, wherein the stabilization driver includes a plurality of stabilization driving circuits, and each of the stabilization driving circuits generates sub-boost signals based on one of the boost voltages, and sequentially applies the sub-boost signals to the pixels based on the color information in response to the gate signals.

4. The display device as claimed in claim 3, wherein each of the stabilization driving circuits includes a plurality of stabilization driving blocks, and each of the stabilization driving blocks includes a voltage control unit that outputs a boost voltage selecting signal in response to the gate signal, and a voltage output unit that selectively outputs one of a first boost voltage and a second boost voltage as one of the sub-boost signals through one of the storage lines based on the boost voltage selecting signal.

5. The display device as claimed in claim 2, wherein each of the boost voltages have a voltage level predetermined based on at least one of color coordinates of a backlight unit of the display device, characteristics of color filters of the display panel, and cell-gaps of the display panel.

6. The display device as claimed in claim 1, wherein polarities of the boost signals are inverted every frame, and the boost signals have a positive voltage level during a first frame, and have a negative voltage level during a second frame that follows the first frame.

7. The display device as claimed in claim 1, wherein a first voltage level of a first boost signal applied by the driving unit to a plurality of first gate pixels arranged along a first gate line is different from a second voltage level of a second boost signal applied by the driving unit to a plurality of second gate pixels arranged along a second gate line, adjacent to the first gate line, during each frame.

8. The display device as claimed in claim 1, wherein the pixels include a plurality of first pixels related to a first color information, a plurality of second pixels related to a second color information, and a plurality of third pixels related to a third color information, wherein the driving unit applies first sub-boost signals to the first pixels to stabilize first pixel voltages of the first pixels, applies second sub-boost signals to the second pixels to stabilize second pixel voltages of the second pixels, and applies third sub-boost signals to the third pixels to stabilize third pixel voltages of the third pixels, and the first sub-boost signals have a first voltage range based on the first color information, the second sub-boost signals have a second voltage range based on the second color information, and the third sub-boost signals have a third voltage range based on the third color information.

9. The display device as claimed in claim 1, wherein the boost signals include a plurality of sub-boost signals, each of the sub-boost signals being related to each color, and a stabilization driver applies the sub-boost signals to the pixels based on the color information.

10. The display device as claimed in claim 9, wherein each of the storage lines includes a plurality of sub-storage lines, each of the sub-storage lines being related to each color, and the stabilization driver applies the sub-boost signals through the sub-storage lines based on the color information.

11. The display device as claimed in claim 10, wherein the sub-storage lines are formed in parallel with a gate line, each of the sub-storage lines being coupled to the pixels related to the color information among pixels coupled to the gate line.

12. A method of driving a display panel, comprising:
sequentially applying a gate signal to a plurality of gate lines of the display panel during each frame;
applying data voltages to a plurality of data lines of the display panel; and
selectively applying boost signals to a plurality of storage lines coupled to storage capacitors of a plurality of pixels of the display panel based on color information related to each of the pixels.

13. The method as claimed in claim 12, wherein applying boost signals includes:
receiving a plurality of boost voltages to generate the boost signals; and
applying the boost signals to the storage capacitors of the pixels in response to the gate signals to stabilize pixel voltages of the pixels based on the color information.

14. The method as claimed in claim 13, wherein levels of the boost voltages vary according to the color information related to the pixels.

15. The method as claimed in claim 13, wherein applying boost signals includes:
generating sub-boost signals based on one of the boost voltages; and
sequentially applying the sub-boost signals to the pixels based on the color information in response to the gate signal.

16. The method as claimed in claim 12, wherein applying boost signals includes:
generating a boost voltage selecting signal in response to the gate signal; and
selectively outputting one of a first boost voltage and a second boost voltage as a sub-boost signal through one of the storage lines based on the boost voltage selecting signal.

17. The method as claimed in claim 12, wherein polarities of the boost signals are inverted every frame, and the boost signals have a positive voltage level during a first frame, and have a negative voltage level during a second frame that follows the first frame.

18. The method as claimed in claim 12, wherein a first voltage level of a first boost signal applied to a plurality of first gate pixels arranged along a first gate line is different from a second voltage level of a second boost signal applied to a plurality of second gate pixels arranged along a second gate line, adjacent to the first gate line, during each frame.

19. The method as claimed in claim 12, wherein the boost signals include a plurality of sub-boost signals, each of the sub-boost signals being related to each color, and the sub-boost signals are applied to the pixels based on the color information.

20. The method as claimed in claim 19, wherein each of the storage lines includes a plurality of sub-storage lines, each of the sub-storage lines being related to each color, and the sub-boost signals are applied through the sub-storage lines based on the color information.
